(19) United States
(12) Patent Application Publication
(10) Pub. No.: US 2017/0200424 A1
(43) Pub. Date: Jul. 13, 2017

(54) TRANSPARENT DISPLAY ASSEMBLY AND DISPLAY DEVICE

(71) Applicant: BOE Technology Group Co., Ltd., Beijing (CN)

(72) Inventors: Kai Xu, Beijing (CN); Lei Huang, Beijing (CN)

(21) Appl. No.: 15/322,871

(22) PCT Filed: Jan. 8, 2016
(86) PCT No.: PCT/CN2016/070477

§ 371 Date: Dec. 29, 2016

(30) Foreign Application Priority Data
Aug. 28, 2015 (CN) 201510542946.5

(51) Int. Cl. G09G 3/36; G09G 3/3225; G09G 3/38

(52) U.S. Cl. CPC G09G 3/3607; G09G 3/38; G09G 3/3225; G09G 2320/066

(57) ABSTRACT

Embodiments of the present disclosure provide a transparent display assembly, including a transparent display panel which has a light emitting face for displaying an image and a back face opposite to the light emitting face. The transparent display assembly further includes a light adjustment structure arranged on a side of the back face of the transparent display panel; in a display mode, the light adjustment structure blocks an background light and prevents the background light from entering the transparent display panel through the light adjustment structure; in a non-display mode, the light adjustment structure allows the background light to enter the transparent display panel through the light adjustment structure.

### CROSS-REFERENCE TO RELATED APPLICATION

This application claims the benefit of Chinese Patent Application No. 201510542946.5 filed on Aug. 28, 2015 in the State Intellectual Property Office of China, the whole disclosure of which is incorporated herein by reference.

### BACKGROUND OF THE INVENTION

Field of the Invention

The present disclosure generally relates to the field of display technology and particularly relates to a high-contrast transparent display assembly and a display device including the same.

Description of the Related Art

As a new display technology, transparent display allows viewers to see the background behind the screen through the display screen. This new display technology expands the application field of the display, and can be used for mobile phones, laptops, display windows, refrigerator doors, car displays, billboards, and so on.

Compared with a conventional LCD panel, an AMOLED (Active-matrix Organic Light-Emitting Diode) panel has a faster response, a higher contrast, a wider viewing angle and other characteristics, and is much favored by people. Owing to its self-luminous advantages, the overall structure of the AMOLED panel is very thin, and has a weak absorption of visible light, a natural light transmittance of which can achieve above 95%. Therefore it can be applied to transparent display. However, when the transparent OLED (Organic Light-Emitting Diode) panel is in a display mode, the natural light can still pass through the transparent OLED panel, resulting in a decreased contrast, and affecting its display performance.

### SUMMARY OF THE INVENTION

The present disclosure has been made to overcome or alleviate at least one aspect of the above mentioned disadvantages.

According to an aspect of the present disclosure, there is provided a transparent display assembly, comprising a transparent display panel having a light emitting face for displaying an image and a back face opposite to the light emitting face, the transparent display assembly further comprises a light adjustment structure arranged on a side of the back face of the transparent display panel; in a display mode, the light adjustment structure prevents background light from entering the transparent display panel through the light adjustment structure; in a non-display mode, the light adjustment structure allows the background light to enter the transparent display panel through the light adjustment structure.

In an embodiment, the light adjustment structure may comprise a transparent cover plate arranged on the side of the back face of the transparent display panel and a light adjustment material layer between the transparent cover plate and the back face of the transparent display panel, in the display mode, controlled by a first electrical signal, the light adjustment material layer background light prevents the background light from entering the transparent display panel through the light adjustment structure; in the non-display mode, controlled by a second electrical signal, the light adjustment material layer allows the background light to enter the transparent display panel through the light adjustment structure.

In an embodiment, the light adjustment structure further comprises a first electrode as least formed on a part of the back face of the transparent display panel and a second electrode opposite to the first electrode, the light adjustment material layer may be provided between the first and second electrodes, and the second electrode being formed on a surface of the transparent cover plate facing the first electrode.

In an embodiment, the light adjustment structure further comprises another transparent cover plate arranged on the back face of the transparent display panel and opposite to the transparent cover plate; a first electrode at least formed a part of a surface of the another transparent cover plate facing the light adjustment material layer; and a second electrode opposite to the first electrode, the light adjustment material layer is provided between the first and second electrodes, and the second electrode is formed on a surface of the transparent cover plate facing the light adjustment material layer.

In an embodiment, at least one of the first and second electrodes comprises a mesh electrode.

In an embodiment, the light adjustment structure further comprises a transparent conductive material layer covering at least one of the first and second electrodes.

In an embodiment, at least one of the first and second electrodes comprises a plate electrode made of a transparent conductive material.

In an embodiment, the light adjustment structure further comprises a sealing frame provided between the transparent cover plate and the back face of the transparent display panel, so as to form a sealed space surrounding the light adjustment material layer and between the transparent cover plate and the back face of the transparent display panel; or, the light adjustment structure further comprises a sealing frame provided between the transparent cover plate and the another transparent cover plate, so as to form a sealed space surrounding the light adjustment material layer and between the transparent cover plate and the another transparent cover plate.

In an embodiment, the sealed space comprises a plurality of compartments which are separated by the sealing frame so as to accommodate the light adjustment material.

In an embodiment, the light adjustment structure further comprises a plurality of first and second strip electrodes formed on a same surface facing the light adjustment material layer, the plurality of first strip electrodes and the plurality of second stripe electrodes being alternately arranged in a linear array and being capable of being applied with different electrical signals to form an edge electric field between a first and second strip electrodes which are adjacent to each other.

In an embodiment, the transparent display panel comprises a transparent OLED display panel having an array substrate and an OLED unit and the light adjustment structure is provided on a side of the array substrate facing away from the OLED unit.

In an embodiment, the transparent cover plate comprises a flexible substrate, and/or the transparent display panel comprises a flexible substrate.

In an embodiment, the light adjustment material layer is a liquid crystal layer and the light adjustment structure further comprises a polarizing layer disposed on each side of the liquid crystal layer; or the light adjustment material layer is an electrochromic material layer.

According to another aspect of the present disclosure, there is provided a display device comprising a transparent display assembly in any one of the above mentioned embodiments.

### BRIEF DESCRIPTION OF THE DRAWINGS

The above and other features of the present disclosure will become more apparent by describing in detail exemplary embodiments thereof with reference to the accompanying drawings, the drawings are schematic and are not intended to limit the present disclosure, in which:

FIG. 1 is a sectional view schematically illustrating the structure of a transparent display assembly according to an exemplary embodiment of the present disclosure, in which the display panel is in a display mode;

FIG. 2 is a sectional view schematically illustrating the structure of a transparent display assembly according to an exemplary embodiment of the present disclosure, in which the display panel is in a non-display mode;

FIG. 3 is a sectional view of a light adjustment structure according to an exemplary embodiment of the present disclosure;

FIG. 4 is a sectional view of a light adjustment structure according to another exemplary embodiment of the present disclosure; and

FIG. 5 is a top view of a light adjustment structure according to an exemplary embodiment of the present disclosure.

### DETAILED DESCRIPTION OF PREFERRED EMBODIMENTS OF THE INVENTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to a general concept of the present disclosure, there is provided a transparent display assembly, comprising a transparent display panel having a light emitting face for displaying an image and a back face opposite to the light emitting face, the transparent display assembly further comprises a light adjustment structure arranged on a side of the back face of the transparent display panel; in a display mode, the light adjustment structure prevents background light from entering the transparent display panel through the light adjustment structure; in a non-display mode, the light adjustment structure allows the background light to enter the transparent display panel through the light adjustment structure. Therefore, the transparent display panel will not be affected by the background light in the display mode, improving the contrast of the displayed image.

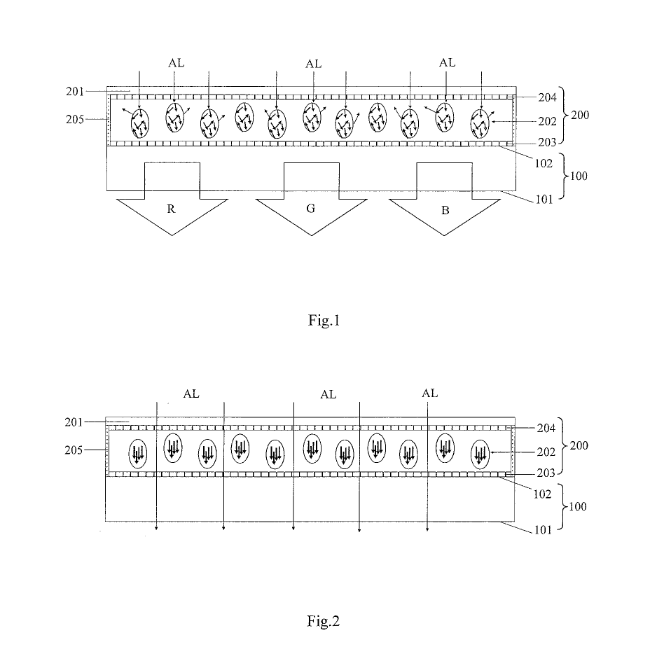

FIG. 1 schematically illustrates the structure of a transparent display assembly according to an exemplary embodiment of the present disclosure, in which the display panel is in a display mode. As shown in FIG. 1, the transparent display assembly comprises a transparent display panel 100 and a light adjustment structure 200 provided on the transparent display panel 100. The transparent display panel 100 has a light emitting face or a front face 101 for displaying an image and a back face 102 opposite to the light emitting face. In the example shown in FIG. 1, the light adjustment structure 200 is arranged on a side of the transparent display panel 100 having the back face 102.

According to the embodiment of the present disclosure, the light adjustment structure 200 is configured that in a non-display mode of the transparent display panel 100, the light adjustment structure 200 allows the background light AL to enter the transparent display panel 100 through the light adjustment structure 200, as shown in FIG. 2, such that the whole assembly still has a relatively high transparency when the display panel doesn't display an image. On the other hand, in a display mode of the transparent display panel 100, for example, when an image is being displayed, as described below, the light adjustment structure 200 can block an background light AL and prevent the background light AL from entering the transparent display panel 100 through the light adjustment structure, as shown in FIG. 1, such that it can avoid a problem that the displayed image is affected by the background light and the visibility is reduced. Therefore, the transparent display panel 100 may display an image with a high contrast. Therefore, a transparent display panel configured with such a light adjustment structure may be used for a transparent display screen to improve the contrast of the displayed image. For example, it can be used in mobile phones, laptops, display windows, desktop transparent displays, refrigerator doors, car displays, billboards, and so on.

Such a light adjustment structure of the present disclosure can be achieved with various ways. For example, the light adjustment structure comprises a transparent cover plate arranged on the back face of the transparent display panel and a light adjustment material layer between the transparent cover plate and the transparent display panel. The light adjustment material layer may employ liquid crystal light adjustment technology, while in other embodiments, the light adjustment material layer may employ an electrochromic material or other light adjustment material, so as to control whether the background light will enter the transparent display panel from the back face or not. The present disclosure is not limited thereto.

For example, as shown in FIGS. 1 and 2, the light adjustment structure 100 comprises a transparent cover plate 201, a liquid crystal layer 202 between the transparent cover plate 201 and the back face 102 of the transparent display panel 100, a first electrode 203 and a second electrode 204 applying a voltage to the liquid crystal layer 202 or causing the liquid crystal molecules in the liquid crystal layer 202 to deflect. The liquid crystal layer 202 is configured to block an background light and prevent the background light from entering the transparent display panel through the light adjustment structure when being applied with a first electrical signal; and allows the background light to enter the transparent display panel 100 through the liquid crystal layer 202 when being applied with a second electrical signal. For example, the liquid crystal layer 202 may have a thickness or height of around 5 micron.

In one example, the first electrode 203 is formed on a side of the back face 102 of the transparent display panel 100, for example, the transparent display panel 100 may be an OLED display panel having an array substrate. The first electrode 203 is provided on a part of the back face of the transparent display panel, while the second electrode 204 is provided on the transparent cover plate 201 and opposite to the first electrode 203, that is, the second electrode 204 is formed on a surface of the transparent cover plate 201 facing the first electrode 203. The liquid crystal layer 202 is provided between the first and second electrodes 203, 204.

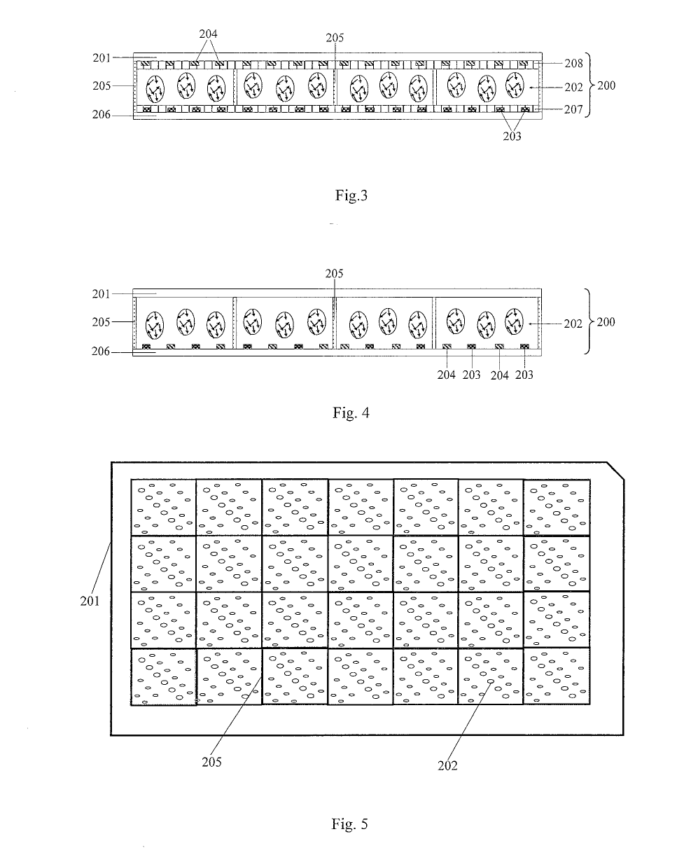

In the embodiment shown in FIGS. 1 and 2, the first electrode 203 is directly provided on the back face 102 of the transparent display panel 100; in other embodiments, as shown in FIGS. 3 and 4, the light adjustment structure 200 further comprises another transparent cover plate 206 provided on the back face 102 of the transparent display panel 100 and opposite to the transparent cover plate 201, such as a glass substrate. The first electrode 203 is provided on a part of a surface of another transparent cover plate 206 facing the liquid crystal layer. The second electrode 204 is formed on the surface of the transparent cover plate 201 facing the liquid crystal layer 202 and opposite to the first electrode 203. The liquid crystal layer 202 is provided between the first and second electrodes 203, 204. Subsequently, the surface of the transparent cover plate 206 facing away from the liquid crystal layer may be bonded to the back face of an array substrate of the transparent display panel.

According to the embodiment of the present disclosure, when the transparent display assembly is in the display mode, for example, it is displaying an image (which is schematically shown in form of RGB), as shown in FIG. 1, the first electrode 203 and the second electrode 204 apply a first electrical signal to the liquid crystal layer 202, at this time, the liquid crystal molecules in the liquid crystal layer 202 are disorderly arranged to prevent the background light AL from the ambient environment from entering the display panel through the light adjustment structure 100 and affecting display of the image. When the transparent display assembly is in the non-display mode, as shown in FIG. 2, the first electrode 203 and the second electrode 204 apply a second electrical signal to the liquid crystal layer 202, and the resulting electric field causes the liquid crystal molecules which are disorderly arranged to deflect and to be arranged in order, so as to allow light AL to pass therethrough, thereby ensuring light transmission of the transparent display assembly in non-display mode.

According to the embodiment of the present disclosure, the first and second electrodes 203 and 204 may be light transmissive, configured to have a light transmissive structure or be arranged in a light transmissive manner. For example, at least one of the first electrode 203 and the second electrode 204 is made of transparent conductive materials, for example, they are formed as a transparent plate electrode, as shown in FIGS. 1 and 2.

Alternatively, as shown in FIGS. 3 and 4, at least one of the first and second electrodes 203 and 204 comprises a mesh electrode, for example a mesh structure formed by metal wires such as Al, Cr, and having light transmittance. Further, at least one of the first and second electrode 203, 204 may further comprise a plurality of linear or strip sub-electrodes. For example, the mesh electrode or the strip electrode may be formed by depositing a metal or conductive material layer on the surface of the cover plate or substrate and then etching such a layer.

In the exemplary embodiment of FIG. 3, the first and second electrodes 203, 204 are opposed to each other with the liquid crystal layer 202 being disposed therebetween. The first electrode 203 and the second electrode 204 apply electrical signal to the liquid crystal layer 202 after being energized, whereby an electric field generated between the first electrode 203 and the second electrode 204 may cause the liquid crystal molecules in the liquid crystal layer 202 to deflect.

In one example, in case that the first electrode 203 and/or the second electrode 204 are formed as a mesh electrode or a strip electrode, in order to improve the conductivity without affecting the light transmission of the panel, a transparent conductive material layer may be formed, for example deposited on the surface of the transparent cover plate and/or the transparent display panel, and it covers at least corresponding electrodes formed on the surface. As shown in FIG. 3, the transparent conductive material layers 207 and 208 are formed which cover the first and second mesh or strip electrodes 203 204 respectively. For example, a transparent conductive material layer, such as ITO (indium tin oxide), is deposited on the whole surface of the transparent cover plate 201 and/or 206, or on the back face 102 of the display panel to cover the corresponding electrodes, after the corresponding mesh or strip electrodes are formed on the surface.

In an alternative embodiment, the light adjustment structure 200 may comprise a plurality of first strip electrodes 203 and a plurality of second strip electrodes 204 formed on a same surface. For example, these strip electrodes are all formed on the surface of the transparent cover plate 201 facing the liquid crystal layer, or are all formed on the surface of the transparent cover plate 206 (see FIG. 4) facing the liquid crystal layer, or are formed on the back face 102 of the display panel. The first stripe electrode 203 and the second stripe electrode 204 are alternately arranged in a linear array on the surface. These strip electrodes may be made of a metal material, for example made of a transparent conductive material, by for example etching a deposited material layer.

Under this situation, when different electrical signals are applied to the first and second strip electrodes 203, 204 which are alternately arranged, an edge electric field is generated between the adjacent first strip electrode 203 and the second strip electrode 204. The edge electric field causes the liquid crystal molecules in the liquid crystal layer 202 to deflect, so that the liquid crystal molecules are arranged in order in the non-display mode of the transparent display panel and allow light to pass therethrough.

In addition, the light adjustment structure 200 may further comprise a sealing frame 205, which may be provided between the transparent cover plate and the back face of the transparent display panel to form a sealed space surrounding the liquid crystal layer 202 and between the transparent cover plate and the back face of the transparent display panel. For example, the sealing frame 205 may be disposed between the transparent cover plates 201 and 206 or between the transparent cover plate 201 and the back face 206 of the display panel.

According to an embodiment of the present invention, the sealing frame 205 may be provided only around the peripheral edges of the transparent cover plate and the display panel, within which a single non-partitioned sealed space for accommodating the liquid crystal layer 202 is formed, as shown in FIGS. 1 and 2. Alternatively, it is possible to provide a plurality of sealing frames 205 or similar supporting structure in the sealed space shown in FIGS. 1 and 2, so as to divide the sealed space into a plurality of small compartments, each of which is filled with an amount of liquid crystal, as shown in FIGS. 3-5. In the example of FIGS. 3-5, the sealing frames 205 can maintain the position of the liquid crystal so that the display panel can be applied to flexible applications, such as a flexible transparent display screen. At this time, the above mentioned transparent cover plate and/or the transparent display panel comprises a flexible substrate.

In the above embodiment, the light adjustment material layer employs a liquid crystal layer and it controls whether the background light enters the transparent display panel from the light adjustment structure or not with the liquid crystal light adjustment technique. When the light adjustment material layer is a liquid crystal layer, the light adjustment structure further comprises a polarizing layer on each side of the liquid crystal layer. In another exemplary embodiment of the present disclosure, the light adjustment material layer comprises an electrochromic material layer. When the transparent display assembly is in the display mode, a first electrical signal can be applied to the electrochromic material layer so that the electrochromic material layer changes its color, for example changes to black, so as to block visible light in the surroundings from entering the transparent display panel through the light adjustment structure. Therefore, the transparent display panel is not affected by the background light when displaying an image, and the contrast of the displayed image is increased. When the transparent display assembly is in the non-display mode, a second electrical signal is applied to the electrochromic material layer, and the electrochromic material layer presents a color allowing the visible light to pass therethrough, thereby the light transmission of the transparent display assembly in the non-display mode is increased.

According to another exemplary embodiment of the present disclosure, there is also provided a display device, comprising a transparent display assembly in any one of the above mentioned embodiments. This kind of display device may be used for transparent display, improving the contrast of the displayed image. For example, it can be used in mobile phones, laptops, display windows, refrigerator doors, car displays, billboards, and so on.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

1. A transparent display assembly, comprising:
a transparent display panel having a light emitting face for displaying an image and a back face opposite to the light emitting face, and
a light adjustment structure arranged on a side of the back face of the transparent display panel;
wherein in a display mode, the light adjustment structure prevents background light from entering the transparent display panel through the light adjustment structure; and
in a non-display mode, the light adjustment structure allows the background light to enter the transparent display panel through the light adjustment structure.

2. The transparent display assembly according to claim 1,
wherein the light adjustment structure comprises a transparent cover plate arranged on the side of the back face of the transparent display panel and a light adjustment material layer between the transparent cover plate and the back face of the transparent display panel, and
wherein in the display mode, controlled by a first electrical signal, the light adjustment material layer prevents the background light from entering the transparent display panel through the light adjustment structure; and
in the non-display mode, controlled by a second electrical signal, the light adjustment material layer allows the background light to enter the transparent display panel through the light adjustment structure.

3. The transparent display assembly according to claim 2,
wherein the light adjustment structure further comprises a first electrode as least formed on a part of the back face of the transparent display panel and a second electrode opposite to the first electrode, the light adjustment material layer being provided between the first and second electrodes, and the second electrode being formed on a surface of the transparent cover plate facing the first electrode.

4. The transparent display assembly according to claim 2,
wherein the light adjustment structure further comprises:
another transparent cover plate arranged on the back face of the transparent display panel and opposite to the transparent cover plate;
a first electrode at least formed on a part of a surface of the another transparent cover plate facing the light adjustment material layer; and
a second electrode opposite to the first electrode, the light adjustment material layer is provided between the first and second electrodes, and the second electrode is formed on a surface of the transparent cover plate facing the light adjustment material layer.

5. The transparent display assembly according to claim 3,
wherein at least one of the first and second electrodes comprises a mesh electrode.

6. The transparent display assembly according to claim 5,
wherein the light adjustment structure further comprises a transparent conductive material layer covering at least one of the first and second electrodes.

7. The transparent display assembly according to claim 3,
wherein at least one of the first and second electrodes comprise a plate electrode made of a transparent conductive material.

8. The transparent display assembly according to claim 2,
wherein the light adjustment structure further comprises a sealing frame provided between the transparent cover plate and the back face of the transparent display panel, so as to form a sealed space surrounding the light adjustment material layer and between the transparent cover plate and the back face of the transparent display panel.

9. The transparent display assembly according to claim 8,
wherein the sealed space comprises a plurality of compartments which are separated by the sealing frame so as to accommodate the light adjustment material.

10. The transparent display assembly according to claim 2,
wherein the light adjustment structure further comprises a plurality of first and second strip electrodes formed on a same surface facing the light adjustment material layer, the plurality of first strip electrodes and the plurality of second stripe electrodes being alternately arranged in a linear array and being adapted to be applied with different electrical signals to form an edge electric field between a first and second strip electrodes which are adjacent to each other.

11. The transparent display assembly according to claim 1,
wherein the transparent display panel comprises a transparent OLED display panel having an array substrate and an OLED unit and the light adjustment structure is provided on a side of the array substrate facing away from the OLED unit.

12. The transparent display assembly according to claim 2,
wherein the transparent cover plate comprises a flexible substrate, and/or the transparent display panel comprises a flexible substrate.

13. The transparent display assembly according to claim 2,
wherein the light adjustment material layer is a liquid crystal layer and the light adjustment structure further comprises a polarizing layer disposed on each side of the liquid crystal layer; or
the light adjustment material layer is an electrochromic material layer.

14. A display device, comprising a transparent display assembly according to claim 1.

15. The transparent display assembly according to claim 4,
wherein at least one of the first and second electrodes comprises a mesh electrode.

16. The transparent display assembly according to claim 15,
wherein the light adjustment structure further comprises a transparent conductive material layer covering at least one of the first and second electrodes.

17. The transparent display assembly according to claim 4,
wherein at least one of the first and second electrodes comprises a plate electrode made of a transparent conductive material.

18. The transparent display assembly according to claim 4,
wherein the light adjustment structure further comprises a sealing frame provided between the transparent cover plate and the another transparent cover plate, so as to form a sealed space surrounding the light adjustment material layer and between the transparent cover plate and the another transparent cover plate.

19. The transparent display assembly according to claim 18,
wherein the sealed space comprises a plurality of compartments which are separated by the sealing frame so as to accommodate the light adjustment material.
